(19) United States
(12) Patent Application Publication
(10) Pub. No.: US 2024/0051828 A1
(43) Pub. Date: Feb. 15, 2024

(54) METHOD FOR PRODUCING ONIUM SULFONYL IMIDE SALTS AND ALKALI METAL SULFONYL IMIDE SALTS

(71) Applicant: RHODIA OPERATIONS, Lyon (FR)

(72) Inventor: Etienne Schmitt, Soucieu-En-Jarrest (FR)

(73) Assignee: RHODIA OPERATIONS, Lyon (FR)

(21) Appl. No.: 18/257,839

(22) PCT Filed: Nov. 25, 2021
(86) PCT No.: PCT/EP2021/082907

§ 371 Date: Jun. 15, 2023

(30) Foreign Application Priority Data
Dec. 16, 2020 (EP) 20306587.5
May 26, 2021 (EP) 21176097.0

(51) Int. Cl. C01B 21/086

(52) U.S. Cl. CPC C01B 21/086; C01P 2002/86; C01P 2006/80; H01M 10/0568

(57) ABSTRACT

The invention relates to a new method for producing an onium salt of bis(fluorosulfonyl)imide and an alkali metal salt of bis(fluorosulfonyl)imide of high purities, as industrial scale, and with a reasonable cost when compared to the other available methods. Said method comprises the steps of reacting bis(chlorosulfonyl)imide or salts thereof with an onium halide other than an onium fluoride to produce an onium salt of bis(chlorosulfonyl)imide, reacting the onium salt of bis(chlorosulfonyl)imide with an onium fluoride to produce an onium salt of bis(fluorosulfonyl)imide; the onium salt of bis(fluorosulfonyl)imide may be further reacted with an alkali metal salt to obtain an alkali metal salt of bis(fluorosulfonyl)imide.

### RELATED APPLICATIONS

This application claims the priority of the patent application filed in Europe on 16 Dec. 2020 with number 20306587.5 and the patent application filed in Europe on 26 May 2021 with number 21176097.0, the whole content of each being incorporated herein by reference for all purposes.

### TECHNICAL FIELD

The present invention relates to a method for producing onium salts of bis(fluorosulfonyl)imide and to a method for preparing alkali metal salts of bis(fluorosulfonyl)imide from said onium salts. More specifically, the invention provides a method for producing these salts of bis(fluorosulfonyl)imide which is economically feasible at industrial scale and which provide high-purity intermediate and final products.

### BACKGROUND ART

Bis(fluorosulfonyl)imide (HFSI) and salts thereof, in particular the lithium salt of bis(fluorosulfonyl)imide (commonly represented by “LiFSI”), are useful compounds in a variety of technical fields.

The production of bis(fluorosulfonyl)imide (and salts thereof) is described in the literature. Among the various technologies described, the majority use a fluorination reaction either with HF or with metal fluorides, like KF, CsF, AsF₃, SbF₃, CuF₂, ZnF₂, SnF₂, PbF₂, BiF₃, etc. Other technologies have been developed, for example using chlorosulfonyl isocyanate in the presence of oleum and of ammonium fluoride or using urea and fluorosulfonic acid.

Bis(fluorosulfonyl)imide (and salts thereof) are especially useful in battery electrolytes. For this type of use, the presence of impurities is an important issue. To suppress the contamination of metal impurities, various processes have been proposed.

WO 2012/108284 discloses a process for producing a fluorosulfonylimide ammonium salt (NH₄FSI) by reacting a specific chlorosulfonylimide ammonium salt (NH₄FSI) with hydrogen fluoride (HF). The obtained NH₄FSI may be reacted with an alkali metal compound (or the like) to produce an alkali metal fluorosulfonylimide salt (or the like). Such method does not provide the NH₄FSI with a sufficiently good yield to prepare an alkali metal fluorosulfonylimide salt therefrom. Additionally, hydrogen chloride is produced as by-product during the synthesis of the NH₄FSI. Further steps of treatment are thus required to manage this effluent.

US 2013/0331609 discloses a process for producing a NH₄FSI including reacting a chlorosulfonlyimide compound with a fluorinating agent of formula NH₄F(HF)ₚ, wherein p is 0 to 10. The NH₄FSI so obtained is then subjected to a cation exchange reaction to produce another fluorosulfonylimide salt. This process is presented as being industrially efficient and as providing a product with no metal impurities. However, such process requires a significant amount of NH₄F(HF)ₚ, the molar ratio NH₄F(HF)ₚ/chlorosulfonlyimide compound being above 4 in the examples. This is because part of the NH₄F(HF)ₚ, which initial purpose is to fluorinate the chlorosulfonlyimide compound, is actually wasted in secondary reactions. Therefore such process is not cost-effective enough to be implemented at an industrial scale.

EP 3381923 discloses a method for producing LiFSI in high yield and purity, which is supposed to be simple and cost-effective. Said method consists in reacting HCSI with a fluorinating reagent such as NH₄F in a solvent, followed by treatment with an alkaline reagent, thereby producing ammonium bis(fluorosulfonyl)imide, and then reacting the NH₄FSI with a lithium base to produce LiFSI. At industrial scale, one major problem of this known method lies in the management of the effluents generated during the manufacturing process. Indeed, high amounts of by-products in the form of solid halogenated salts need to be removed, treated or destroyed, which represents a waste of time, of energy and an additional cost. Another issue lies in the possible exothermicity of the fluorination reaction. As this reaction is generally conducted in an organic solvent, the heat generated degrades at least partially the organic solvent, which increases the level of impurities in the NH₄FSI prepared, especially the TOC (total organic carbon) content. Further treatments of the salts of bis(fluorosulfonyl)imide obtained thereby are thus necessary to achieve the required purity for a usage in electronic applications such as batteries electrolytes. These treatments also represent a supplementary cost and may not be sufficient to get the expected specifications for the targeted bis(fluorosulfonyl)imide salts.

There is still room for improvement for a method for producing bis(fluorosulfonyl)imide and salts thereof, especially onium salts of bis(fluorosulfonyl)imide (onium salts of FSI) and alkali metal salts of bis(fluorosulfonyl)imide (alkali salts of FSI), which is economically feasible at industrial scale and which provides high-purity products.

EP 3203570 relates to a fluorosulfonyl imide and an electrolyte material containing N-(fluorosulfonyl)-N-(fluoroalkylsulfonyl)imide and di(fluorosulfonyl)imide, in which the residual solvent, which influences the characteristics of the electrolyte material, is reduced to 300 ppm or less. In production example 1, the step of preparation of NH₄CSI takes place in an organic solvent which is butyl acetate. Such solvent needs to be removed after reaction in order to obtain an as pure as possible product which can be used for battery applications. The step for removing the solvent adds to the complexity of the industrial process, as well as its overall cost. In addition, before being implemented in such processes, the solvents typically have to be treated to remove the residual amount water, as only anhydrous solvent, where the residual amount of water is in the ppm amount, are actually to be used.

An object of the present invention is to provide a simpler production process of salts of bis(fluorosulfonyl)imide, which does not require the distillation of the reaction solvent.

### BRIEF DESCRIPTION OF THE INVENTION

The Applicant provides hereafter a method for producing an onium salt of bis(fluorosulfonyl)imide (onium salt of FSI) as well as a method for manufacturing an alkali metal salt of bis(fluorosulfonyl)imide (alkali metal salt of FSI) from the obtained onium salt of FSI.

One object of the present invention is a method for producing an onium salt of bis(fluorosulfonyl)imide (onium salt of FSI), comprising the steps of:
a) reacting a bis(chlorosulfonyl)imide or a salt thereof with an onium halide other than an onium fluoride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a),
b) reacting the onium salt of CSI with an onium fluoride to produce an onium salt of FSI.

Another object of the present invention is a method for producing an alkali metal salt of bis(fluorosulfonyl)imide (alkali salt of FSI), comprising the steps of:
a) reacting a bis(chlorosulfonyl)imide or a salt thereof with an onium halide other than an onium fluoride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a),
b) reacting the onium salt of CSI with an onium fluoride to produce an onium salt of FSI,
c) reacting the onium salt of FSI with an alkali metal salt to obtain an alkali metal salt of FSI.

The invention also discloses the intermediate and final products obtainable by the above methods: especially the onium salt of bis(chlorosulfonyl)imide (CSI) obtainable at the end of step a); the onium salt of bis(fluorosulfonyl)imide (FSI) obtainable at the end of step b); the alkali salt of bis(fluorosulfonyl)imide (FSI) obtainable at the end of step c).

The salts resulting from the process according to the invention are provided with a high purity, especially a low level of TOC impurities. The manufacturing methods thereof are suitable for being implemented at industrial scale, with a reasonable cost when compared to the other available methods. Especially, the amount of effluents in the form of solid halogenated salts is reduced. One additional advantage of the process according to the present invention is that the main byproducts generated thereby in step a), b) and/or c) can be valued: instead of representing an additional burden to deal therewith as it is for the known processes, the main by-products of the process of the invention may especially be recycled by use thereof in one or more steps of the process of the invention or by reacting them together to prepare an onium halide that may be used in step a) and/or b). Thus, the process of the invention advantageously avoids further treatments steps of the effluents to destroy them and increases the profitability of the industrial process by making use thereof. Additionally, the fluorination reaction involved in the process according to the present invention is advantageously athermic. Thus, if an organic solvent is used to perform this reaction, the above-mentioned problems of degradation of the organic solvent are avoided, which leads to an improved purity (especially lower level of TOC impurities) of the onium salt of bis(fluorosulfonyl)imide and consequently of the alkali metal salt of bis(fluorosufonyl)imide obtainable therefrom.

### DESCRIPTION OF THE INVENTION

In the present disclosure:
the expressions “comprised between . . . and . . . ” as well as “ranging from . . . to . . . ” or the like should be understood as including the limits;
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

Step a)

The step a) of the method according to the invention consists in reacting a bis(chlorosulfonyl)imide or a salt thereof with an onium halide other than an onium fluoride to produce an onium salt of bis(chlorosulfonyl)imide (CSI).

Bis(chlorosulfonyl)imide as such or a salt thereof is used as raw material. It may be represented by the formula:

(Cl—SO₂—N⁻—SO₂—Cl)M⁺ (I)
wherein M represents one element from the group consisting of H, Li, Na, K, and Cs.

According to a preferred embodiment, the raw material is bis(chlorosulfonyl)imide of formula (Cl—SO₂)₂—NH (commonly represented by HCSI). HCIS is commercially available, or produced by a known method, for example:
by reacting chlorosulfonyl isocyanate ClSO₂NCO with chlorosulfonic acid ClSO₂OH;
by reacting cyanogen chloride CNCl with sulfuric anhydride SO₃, and with chlorosulfonic acid ClSO₂OH;
by reacting sulfamic acid NH₂SO₂OH with thionyl chloride SOCl₂ and with chlorosulfonic acid ClSO₂OH.

According to the present invention, step a) is carried out in molten bis(chlorosulfonyl)imide (or salt thereof), in the absence of solvent or in the presence of a solvent less than 5 wt. % based on the total weight of the reaction mixture involved in step a). Importantly, step a) of the method of the present invention is a solvent-free step. In other words, no solvent/diluent, alternatively a very low amount of solvent/diluent, is added to the reaction mixture during the reaction of step a). Carrying out step a) without adding any further solvent is especially advantageous. Indeed, the use of solvents during such steps implies that the solvent(s) will have to be removed after reaction in order to obtain an as pure as possible product which can be used for battery applications. The step for removing the solvent adds to the complexity of the industrial process, as well as its overall cost. In addition, before being implemented in such processes, the solvents typically have to be treated to remove the residual amount water, as only anhydrous solvent, where the residual amount of water is in the ppm amount, are actually to be used. It is therefore a main advantage that step a) of the present process is solvent-free. Deleterious reaction which could occur between a hydrogen halide by-product formed in step a) and the solvent possibly used can be avoided. Additionally, because the step for removing the solvent is not needed for step a), the present invention overall provides a simpler production process of salts of bis(fluorosulfonyl)imide, significantly decreasing the complexity of the industrial process, as well as its overall cost.

According to an alternative but less preferred embodiment, step a) is carried out or in the presence of a very low amount of solvent, that-is-to-say an amount of solvent less than 5 wt. %, based on the total weight of the reaction mixture involved in step a). Preferably, according to this embodiment, the amount of solvent is less than 4 wt. %, less than 3 wt. %, less than 2 wt. %, less than 1 wt. %, less than 0.5 wt. %, less than 0.1 wt. %, less than 0.01 wt. %, or less than 0.001 wt. % of solvent, based on the total weight of the reaction mixture. The total weight of the reaction mixture is obtained by adding the weight of the reactants, as well as the weight of the molten salt of bis(fluorosulfonyl)imide.

Solvents which are typically used in such processes are well-known and extensively described in the literature. Such solvents may be aprotic, for example polar aprotic solvents, and may selected from the group consisting of
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl-substituted alkane or aromatic hydrocarbon, for instance acetonitrile, valeronitrile, adiponitrile, benzonitrile, nitromethane, nitrobenzene.

More preferably, if an organic solvent is used to carry out step a), the organic solvent may be selected from the group consisting of ethyl acetate, isopropyl acetate, butyl acetate, ethylene carbonate, dimethyl carbonate, ethyl methyl carbonate, propylene carbonate, valeronitrile and acetonitrile.

If a solvent is used to conduct step a), according to a preferred embodiment, the organic solvent is anhydrous. Moisture content may be preferably below 5,000 ppm, more preferably below 1,000 ppm, more preferably below 500 ppm, more preferably below 100 ppm even more preferably below 50 ppm.

Said bis(chlorosulfonyl)imide or the salt thereof is reacted with an onium halide other than an onium fluoride.

A suitable onium halide for carrying out step a) may be especially selected from onium chlorides, onium iodides and onium bromides. The onium halide is preferably an onium chloride to avoid a possible substitution of one or both of the chlorine atoms in the bis(chlorosulfonyl)imide by a different halide.

In the framework of the invention, a cation “onium” has the usual meaning for the skilled person.

Examples of the onium cation include phosphonium cation, oxonium cation, sulfonium cation, fluoronium cation, chloronium cation, bromonium cation, iodonium cation, selenonium cation, telluronium cation, arsonium cation, stibonium cation, bismutonium cation; iminium cation, diazenium cation, nitronium cation, diazonium cation, nitrosonium cation, hydrazonium cation, diazenium dication, diazonium dication, imidazolium cation, pyridinium cation, quaternary ammonium cation, tertiary ammonium cation, secondary ammonium cation, primary ammonium cation, ammonium NH₄⁺ cation, piperidinium cation, pyrrolidinium cation, morpholinium cation, pyrazolium cation, guanidinium cation, isouronium cation and isothiouronium cation.

Among these, imidazolium cation, pyridinium cation, quaternary ammonium cation, tertiary ammonium cation, secondary ammonium cation, primary ammonium cation, ammonium NH₄⁺ cation, piperidinium cation, pyrrolidinium cation, morpholinium cation, pyrazolium cation, guanidinium cation, and isouronium cation are more preferred.

Examples of onium cations of these types include:
imidazolium cations such as a 1,3-dimethylimidazolium cation, 1-ethyl-3-methylimidazolium cation, 1-propyl-3-methylimidazolium cation, 1-butyl-3-methylimidazolium cation, 1-pentyl-3-methylimidazolium cation, 1-hexyl-3-methylimidazolium cation, 1-heptyl-3-methylimidazolium cation, 1-octyl-3-methylimidazolium cation, 1-decyl-3-methylimidazolium cation, 1-tetradecyl-3-methylimidazolium cation, 1-hexadecyl-3-methylimidazolium cation, 1-octadecyl-3-methylimidazolium cation, 1-allyl-3-ethylimidazolium cation, 1-allyl-3-butylimidazolium cation, 1,3-diallylimidazolium cation, 1-ethyl-2,3-dimethylimidazolium cation, 1-butyl-2,3-dimethylimidazolium cation, 1-hexyl-2,3-methylimidazolium cation, and 1-hexadecyl-2,3-methylimidazolium cation;
pyridinium cations such as a 1-ethylpyridinium cation, 1-butylpyridinium cation, 1-hexylpyridinium cation, 1-octylpyridinium cation, 1-ethyl-3-methylpyridinium cation, 1-ethyl-3-hydroxymethylpyridinium cation, 1-butyl-3-methylpyridinium cation, 1-butyl-4-methylpyridinium cation, 1-octyl-4-methylpyridinium cation, 1-butyl-3,4-dimethylpyridinium cation, and 1-butyl-3,5-dimethylpyridinium cation;
quaternary ammonium cations such as a tetramethylammonium cation, tetraethylammonium cation, tetrapropylammonium cation, tetrabutylammonium cation, tetraheptylammonium cation, tetrahexylammonium cation, tetraoctylammonium cation, triethylmethylammonium cation, propyltrimethylammonium cation, diethyl-2-methoxyethylmethylammonium cation, methyltrioctylammonium cation, cyclohexyltrimethylammonium cation, 2-hydroxyethyltrimethylammonium cation, trimethylphenylammonium cation, benzyltrimethylammonium cation, benzyltributylammonium cation, benzyltriethylammonium cation, dimethyldistearylammonium cation, diallyldimethylammonium cation, 2-methoxyethoxymethyltrimethylammonium cation, N-methoxytrimethylammonium cation, N-ethoxytrimethylammonium cation, N-propoxytrimethylammonium cation and tetrakis(pentafluoroethyl)ammonium cation;
tertiary ammonium cations such as a trimethylammonium cation, triethylammonium cation, tributylammonium cation, diethylmethylammonium cation, dimethylethylammonium cation, dibutylmethylammonium cation, and 4-aza-1-azoniabicyclo[2.2.2]octane cation;
secondary ammonium cations such as a dimethylammonium cation, diethylammonium cation, and dibutylammonium cation;
primary ammonium cations such as a methylammonium cation, ethylammonium cation, butylammonium cation, hexylammonium cation, and octylammonium cation;
ammonium cation NH₄⁺;
piperidinium cations such as a 1-propyl-1-methylpiperidinium cation and 1-(2-methoxyethyl)-1-methylpiperidinium cation;
pyrrolidinium cations such as a 1-propyl-1-methylpyrrolidinium cation, 1-butyl-1-methylpyrrolidinium cation, 1-hexyl-1-methylpyrrolidinium cation, and 1-octyl-1-methylpyrrolidinium cation;
morpholinium cations such as a 4-propyl-4-methylmorpholinium cation and 4-(2-methoxyethyl)-4-methylmorpholinium cation;
pyrazolium cations such as a 2-ethyl-1,3,5-trimethylpyrazolium cation, 2-propyl-1,3,5-trimethylpyrazolium cation, 2-butyl-1,3,5-trimethylpyrazolium cation, and 2-hexyl-1,3,5-trimethylpyrazolium cation;
guanidinium cations such as a guanidinium cation and a 2-ethyl-1,1,3,3-tetramethylguanidinium cation; and
isouronium cations such as a 2-ethyl-1,1,3,3-tetramethylisouronium cation.

Quaternary ammonium cation, tertiary ammonium cation, secondary ammonium cation, primary ammonium cation, and ammonium cation NH₄⁺ are more preferred, especially those specifically cited in the above list. Ammonium cation NH₄⁺ is the most preferred onium cation.

According to a preferred embodiment, the onium halide used in step a) is anhydrous. Moisture content may be preferably below 5,000 ppm, more preferably below 1,000 ppm, more preferably below 500 ppm, more preferably below 100 ppm even more preferably below 50 ppm.

The molar ratio of the onium halide to the bis(chlorosulfonyl)imide or salt thereof in step a) may range from 0.001:1 to 20:1, in particular from 0.1:1 to 10:1, more particularly from 0.5:1 to 5:1. Even more particularly, it may be of about 1:1.

The reaction in step a) may be carried out at a temperature ranging from 35° C. to 150° C., in particular from 50° C. to 110° C., more particularly from 55° C. to 95° C. Several temperature increments may be performed in this range, for instance 2.

Preferably, the reaction in step a) is carried out at atmospheric pressure, but it is not excluded to work below or above atmospheric pressure, for instance between 800 mbar and 1.2 bar.

The reaction in step a) may advantageously be carried out under inert atmosphere to avoid moisture contamination.

The reaction in step a) may be carried out in a batch, semi-batch or continuous mode.

According to a preferred embodiment, the bis(chlorosulfonyl)imide is pre-heated by any known method so as to use it in step a) in melted molten state. Then, the onium halide may be added thereto.

Depending on the nature of the onium cation of the onium halide used, the reaction carried out in step a) results in the formation of the corresponding onium salt of bis(chlorosulfonyl)imide (CSI). More particularly when an ammonium halide is used, such as ammonium chloride in particular, ammonium bis(chlorosulfonyl)imide NH₄CSI is formed.

A hydrogen halide (other than hydrogen fluoride) is formed as by-product in the reaction carried out in step a). This by-product may be eliminated by conventional methods known by the skilled person. More advantageously, it may alternatively be recycled, especially to prepare an onium halide that may be used in step a) of the process according to the present invention. Any mean well known by the skilled person may be used in that respect. In particular, after isolation thereof, the hydrogen halide may be purified before being reengaged in a subsequent reaction. According to a particular embodiment of the invention wherein an alkali metal hydroxide (or hydrate thereof) is used as alkali metal salt to carry out step c) of the process of the invention, the hydrogen halide by-product formed in step a) may be reacted with the onium hydroxide by-product formed in step c) to prepare an onium halide that may advantageously be used to carry out step a). The conditions according to which such a reaction may be carried out are known by the skilled person. Especially, the respective by-products may be isolated and further purified before their reengagement in said reaction. Such recycling loops are very suitable to improve the cost-efficiency and environmental impact of the process.

Before implementing step b) the onium salt of CSI may be further purified by any purification method which is well known by a skilled person, such as vacuum, especially to evacuate the residual onium halide, and/or one or more washings, without being particularly limited to such methods. According to a preferred embodiment, the onium salt of bCSI obtained at the end of step a) is directly used in step b) without any further purification treatment.

One object of the invention is the onium salt of CSI obtained, obtainable or able to be obtained at the end of step a) or any of the optional steps which may be carried out after step a) and before step b) as described above, of the method according to the present invention. Such onium salt is preferably obtained according to the embodiment wherein step a) is carried out without solvent or with an amount of solvent which is as low as possible. This is preferably NH₄CSI.

Advantageously, such an onium salt of CSI has a very high purity. It may show:
a purity of the onium salt of CSI above 90 wt. %, preferably above 95 wt. %, more preferably between 99 wt. % and 100 wt. %; and/or
a content of solvent below 5 wt. %, preferably below 4 wt. %, below 3 wt. %, below 2 wt. %, below 1 wt. %, for example between 0 wt. % and 1 wt. %, or between 0.001 wt. % and 1 wt. %, preferably equals to 0.0 wt. % (based on the equipment detection limits); and/or
a Total Organic Content (TOC) level of less than 15 ppm, in particular less than 10 ppm, more particularly less than 5 ppm, even more particularly less than 1 ppm.

Preferably, such an onium salt of CSI may show the following contents of anions (which are compounds different from the onium salt of bis(chlorosulfonyl)imide as such):
a chloride (Cl⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or
a fluoride (F⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or
a sulfate (SO₄²⁻) content of below 30,000 ppm, preferably below 10,000 ppm, more preferably below 5,000 ppm.

Preferably, it may show the following contents of metal elements:
an iron (Fe) content of below 1,000 ppm, preferably below 800 ppm, more preferably below 500 ppm; and/or
a chromium (Cr) content of below 1,000 ppm, preferably below 800 ppm, more preferably below 500 ppm; and/or
a nickel (Ni) content of below 1,000 ppm, preferably below 800 ppm, more preferably below 500 ppm; and/or
a zinc (Zn) content of below 1,000 ppm, preferably below 100 ppm, more preferably below 10 ppm, and/or
a copper (Cu) content of below 1,000 ppm, preferably below 100 ppm, more preferably below 10 ppm; and/or
a bismuth (Bi) content of below 1,000 ppm, preferably below 100 ppm, more preferably below 10 ppm.

Additionally, it may show:
a sodium (Na) content of below 10,000 ppm, preferably below 5,000 ppm, more preferably below 500 ppm, and/or
a potassium (K) content of below 10,000 ppm, preferably below 5,000 ppm, more preferably below 500 ppm.

Thanks to its very high purity, such an onium salt of CSI, which is preferably NH₄CSI, obtainable by the method according to the invention, may be advantageously used as intermediate product for synthesizing an onium salt of FSI as it will be descried thereafter.

Step b)

According to the present invention, the onium salt of CSI is reacted in step b) with an onium fluoride to produce an onium salt of FSI.

The cation onium of the onium fluoride used in step b) may advantageously be selected among the list of onium cations described above in connection with step a). It is preferably the same as the cation onium of the onium halide used in step a) but it may alternatively be a different one.

Preferably, the onium fluoride used in step b) is ammonium fluoride NH₄F or an adduct thereof or any combination thereof. Even more preferably the onium fluoride used in step b) is NH₄F.

The onium fluoride may be commercially available, or produced by a known method.

The molar ratio of the onium fluoride to the onium salt of CSI in step b) may range from 2:1 to 20:1, in particular from 2:1 to 5:1, more particularly from 2:1 to 3:1, even more particularly from 2:1 to 2.5:1. It is interesting to note that the present invention makes it possible to use just the sufficient amount of onium fluoride to fluorinate the CSI onium salt compared to the processes of the state of the art needing huge amounts of NH₄F to form NH₄FSI. This is rendered possible by the present invention which separates in two different steps the cation exchange reaction involving the bis(chlorosulfonyl)imide from the fluorination reaction involving the onium salt of CSI. In this way, the onium fluoride used in step b) is not spoiled in secondary reactions with the bis(chlorosulfonyl)imide. It is dedicated instead to the fluorination of the onium salt of bis(chlorosulfonyl)imide.

According to a preferred embodiment, the onium fluoride is anhydrous. Moisture content may be preferably below 5,000 ppm, more preferably below 1,000 ppm, even more preferably below 500 ppm.

The reaction in step b) is preferably carried out in an organic solvent. Said organic solvent may be selected from the aprotic organic solvents, preferably:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl-substituted alkane or aromatic hydrocarbon, for instance acetonitrile, valeronitrile, adiponitrile, benzonitrile, nitromethane, nitrobenzene.

According to a preferred embodiment, the organic solvent is selected from the group consisting of ethyl acetate, isopropyl acetate, butyl acetate, ethylene carbonate, dimethyl carbonate, ethyl methyl carbonate, propylene carbonate, valeronitrile and acetonitrile.

According to a preferred embodiment, the organic solvent which may be used in step b) is anhydrous. Moisture content may be preferably below 5,000 ppm, more preferably below 1,000 ppm, more preferably below 500 ppm, more preferably below 100 ppm even more preferably below 50 ppm.

If a solvent (minimal amount) is used in step a), it is preferable to select the same solvent for carrying out step b). It enables to conduct step a) and b) consecutively. However, this is not compulsory.

In one embodiment, the onium salt of CSI obtained from step a) may be dissolved in as amount of the organic solvent chosen to carry out step b) to form a solution. In another embodiment, the onium fluoride may be suspended in an amount of the organic solvent chosen to carry out step b) to form a suspension. It may be possible according to the present invention to combine such resulting solution and suspension in order to perform the reaction under step b) and prepare the onium salt of FSI.

The reaction in step b) may be carried out at a temperature of between 0° C. and 200° C., preferably, between 30° C. and 100° C. Preferably, the reaction is carried out at atmospheric pressure, but it is not excluded to work below or above atmospheric pressure, for instance between 800 mbar and 1.2 bar.

The reaction in step b) may be carried out in a batch, semi-batch or continuous mode.

An onium chloride is formed as by-product in the reaction carried out in step b). This by-product may be eliminated by conventional methods known by the skilled person. More advantageously, it may alternatively be recycled by use thereof to carry out step a), as it is a suitable onium halide in the framework of the present invention. The skilled person knows how to isolate by-products of the onium chloride type from a reaction medium. The recycling operation may include one or more purification steps of the onium chloride before using it in step a). Any conventional method known by the skilled person may be used in that respect. Such a recycling loop is very suitable to improve the cost-efficiency and environmental impact of the process.

By reacting the onium salt of CSI with the onium fluoride according to the present invention, an onium salt of FSI can be obtained.

Another object of the present application is a method for producing an alkali salt of bis(fluorosulfonyl)imide (FSI), comprising the steps of:
a) reacting a bis(chlorosulfonyl)imide or a salt thereof with an onium halide other than an onium fluoride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a),
b) reacting the onium salt of CSI with an onium fluoride to produce an onium salt of bis(fluorosulfonyl)imide (FSI),
c) reacting the onium salt of FSI with an alkali metal salt to obtain an alkali metal salt of bis(fluorosulfonyl)imide (FSI).

Steps a) and b) have been described above. An onium salt of CSI is obtained thereby. One or more optional steps may be performed after step b) and before carrying out step c). The method may thus comprise at least one further step selected from a separation, concentration, crystallization, washing, and/or drying of the onium salt of FSI and/or addition of a basic compound in the reaction medium (such reaction medium resulting from the reaction carried out in step b)). Each of these steps may be repeated and the sequence thereof may be in any order.

Such further step may be for example one or more separation steps, to isolate the onium salt of FSI from the reaction medium. This may be required for instance when a different solvent from the one which may be used in step b) is to be used in step c). This separation may be performed by any typical separation means known by the person skilled in the art, for example by filtration (for instance under pressure or under vacuum) or decantation. Liquid-liquid extraction can also be performed whenever necessary.

In order to purify further the onium salt of FSI obtained at the end of step b), an additional step may consist in adding a basic compound to the reaction medium, for instance selected from the group consisting of gaseous ammonia, ammonia water, amines, hydroxide, carbonates, phosphates, silicates, borates, formates, acetates, stearates, palmitates, propionates or oxalates of alkali or alkaline-earth metal, being preferably gaseous ammonia or ammonia water. The molar ratio basic compound/onium salt of bis(fluorosulfonyl)imide may range from 0.001:1 to 10:1, preferably from 0.005:1 to 5:1, more preferably from 0.005:1 to 3:1. The temperature during the addition of the basic compound may range from 0 to 100° C., preferably from 0 to 90° C., preferably from 15 to 60° C., advantageously at the same temperature than step b).

Also for purification purpose, one or more crystallization steps of the onium salt of FSI may be performed, typically by use of one or more precipitation solvents. In that respect, it may be possible to concentrate first the onium salt of FSI within the reaction medium, typically by evaporating a part of the organic solvent possibly present in the reaction medium, by heating, by decreasing the pressure, or both. The skilled person may use any known method to do so, such as distillation. The precipitation solvent is preferably selected among the organic solvents which are highly soluble within the organic solvent possibly used in step b), and which are poor solvent for the onium salt of FSI. Said precipitation solvent may be selected from the group consisting of halogenated solvents like dichloromethane, dichloroethane, chloroform, and carbon tetrachloride; substituted aromatic hydrocarbon solvents like chlorobenzene, dichlorobenzene and toluene; alkane solvents like cyclohexane, hexane, heptane, and Isopar™; preferably among dichloromethane and dichloroethane. Alternatively, in combination therewith or in an additional separate crystallization step, the precipitation solvent may be selected from halogenated alcohols. Accordingly, the halogenated alcohol may be preferably selected from the group consisting of nonafluoro-tert-butanol ((CF₃)₃COH), hexafluoroisopropanol ((CF₃)₂CHOH), pentafluorophenol, difluoroethanol (HCF₂CH₂OH), and trifluoroethanol (CF₃CH₂OH), more preferably selected from difluoroethanol and trifluoroethanol, and even more preferably being trifluoroethanol. Regardless of the precipitation solvent used, it may be used alone, in combination with another precipitation solvent such as one of those listed above or in combination with another solvent, for instance selected from the group consisting of carbonates like ethyl methyl carbonate (EMC), and dimethyl carbonate (DMC); esters like ethyl acetate, butyl acetate, and ethyl propionate; nitrile compounds like valeronitrile, and acetonitrile; cyclic ethers like 1,4-dioxane. Such one or more crystallisation step(s) may optionally be performed as described in WO 2020/099527.

Among the possible further steps which may be performed after step b) and before step c), one or more washing step(s) of the onium salt of FSI may be performed with any suitable solvent, especially the same one as the one possibly used to carry out step b) and/or step c).

One or more drying step(s) may also be carried out after step b) and before step c), so as to obtain a dry onium salt of FSI. Such a drying step may be carried out by any means known by the person skilled in the art, typically under reduced pressure and/or by heating and/or with an inert gas flow, typically a nitrogen flow.

Advantageously, the onium salt of FSI obtained at the end of step b) or after one or several of the subsequent optional steps described above, of the method according to the invention, has a very high purity. It may show:
a purity of the onium salt of bis(fluorosulfonyl)imide above 90 wt. %, preferably above 95 wt. %, more preferably between 99 wt. % and 100 wt. %; and/or
a content of solvent below 5 wt. %, less than 4 wt. %, less than 3 wt. %, less than 2 wt. %, less than 1 wt. %, for example between 0 wt. % and 1 wt. % or between 0.001 wt. % and 1 wt. %; and/or
a Total Organic Content (TOC) level of less than 15 ppm, in particular less than 10 ppm, more particularly less than 5 ppm, even more particularly less than 1 ppm.

One object of the present invention thus relates to the onium salt of FSI obtained, obtainable or able to be obtained, at the end of step b) or any of the optional steps which may be carried out after step b) and before step c) as described above.

Preferably, it may show the following contents of anions (which are compounds different from the onium salt of bis(fluorosulfonyl)imide as such):
a chloride (Cl⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or
a fluoride (F⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or.
a sulfate (SO₄²⁻) content of below 30,000 ppm, preferably below 10,000 ppm, more preferably below 5,000 ppm.

Preferably, it may show the following contents of metal elements:
an iron (Fe) content of below 1,000 ppm, preferably below 800 ppm, more preferably below 500 ppm; and/or
a chromium (Cr) content of below 1,000 ppm, preferably below 800 ppm, more preferably below 500 ppm; and/or
a nickel (Ni) content of below 1,000 ppm, preferably below 800 ppm, more preferably below 500 ppm; and/or
a zinc (Zn) content of below 1,000 ppm, preferably below 100 ppm, more preferably below 10 ppm, and/or
a copper (Cu) content of below 1,000 ppm, preferably below 100 ppm, more preferably below 10 ppm; and/or
a bismuth (Bi) content of below 1,000 ppm, preferably below 100 ppm, more preferably below 10 ppm.

Additionally, it may show:
a sodium (Na) content of below 10,000 ppm, preferably below 5,000 ppm, more preferably below 500 ppm, and/or
a potassium (K) content of below 10,000 ppm, preferably below 5,000 ppm, more preferably below 500 ppm.

Thanks to its very high purity, the onium salt of FSI, which is preferably NH₄FSI, obtainable by the method according to the invention, may be advantageously used as intermediate product for synthesizing another bis(fluorosulfonyl)imide salt, especially an alkali metal salt of bis(fluorosulfonyl)imide, as it will be descried thereafter.

Step c)

The onium salt of FSI is advantageously reengaged into a further reaction. Indeed, the method according to the present invention comprises a further step c) consisting in reacting the onium salt of FSI with an alkali metal salt in order to obtain an alkali metal salt of bis(fluorosulfonyl)imide (alkali salt of FSI).

The onium salt of FSI may be used as such or solubilized in a solvent, according to the nature of the alkali metal salt. According to a preferred embodiment, the onium salt of FSI is solubilized in an organic solvent, hereafter called “alkalinization solvent”. The alkalinization solvent may be the same or different from the reaction solvent possibly used in step b). Advantageously, the alkalinization solvent of step c) is the same as the reaction solvent possibly used in step b). Said alkalinization solvent may be selected from the aprotic organic solvents, preferably:
cyclic and acyclic carbonates, for instance ethylene carbonate, propylene carbonate, butylene carbonate, dimethyl carbonate, ethyl methyl carbonate, diethyl carbonate,
cyclic and acyclic esters, for instance gamma-butyrolactone, gamma-valerolactone, methyl formate, methyl acetate, methyl propionate, ethyl acetate, ethyl propionate, isopropyl acetate, propyl propionate, butyl acetate,
cyclic and acyclic ethers, for instance diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, 1,4-dioxane,
amide compounds, for instance N,N-dimethylformamide, N-methyl oxazolidinone,
sulfoxide and sulfone compounds, for instance sulfolane, 3-methylsulfolane, dimethylsulfoxide,
cyano-, nitro-, chloro- or alkyl-substituted alkane or aromatic hydrocarbon, for instance acetonitrile, valeronitrile, adiponitrile, benzonitrile, nitromethane, nitrobenzene.

According to a preferred embodiment, the alkalinization solvent is selected from the group consisting of ethyl acetate, isopropyl acetate, butyl acetate, ethylene carbonate, dimethyl carbonate, ethyl methyl carbonate, propylene carbonate, valeronitrile and acetonitrile.

The alkali metal salt may be selected from the group consisting of lithium salt, sodium salt and potassium salt. Preferably, the alkali metal salt is a lithium salt, and the alkali metal salt of FSI obtained by the method according to the invention is a lithium salt of FSI.

Examples of alkali metal salts include alkali metal hydroxides, alkali metal hydroxide hydrates, alkali metal carbonates, alkali metal hydrogen carbonates, alkali metal chlorides, alkali metal fluorides, alkali metal alkoxide compounds, alkyl alkali metal compounds, alkali metal acetates, and alkali metal oxalates. Preferably, an alkali metal hydroxide or an alkali metal hydroxide hydrate may be used in step c). If the alkali metal salt is a lithium salt, then the lithium salt may be selected from the group consisting of lithium hydroxide LiOH, lithium hydroxide hydrate LiOH·H₂O, lithium carbonate Li₂CO₃, lithium hydrogen carbonate LiHCO₃, lithium chloride LiCl, lithium fluoride LiF, lithium alkoxide compounds such as CH₃OLi and EtOLi; alkyl lithium compounds such as EtLi, BuLi and t-BuLi, lithium acetate CH₃COOLi, and lithium oxalate Li₂C₂O₄. Preferably, lithium hydroxide LiOH or lithium hydroxide hydrate LiOH·H₂O may be used in step c).

Said alkali metal salt may be added in step c) as a solid, as a pure liquid or as an aqueous or organic solution.

The molar ratio alkali metal salt/onium salt of FSI used in step c) is preferably comprised between 0.5:1 and 5:1, more preferably between 0.9:1 and 2:1, and even more preferably between 1:1 and 1.5:1.

The reaction in step c) may be carried out at a temperature of between 0° C. and 50° C., more preferably between 15° C. and 35° C., and even more preferably at about the room temperature. Preferably, the reaction is carried out at atmospheric pressure, but it is not excluded to work below or above atmospheric pressure, for instance between 5 mbar and 1.5 bar, preferably between 5 mbar and 100 mbar.

Further treatments may be carried out in order to recover very pure alkali metal salt of FSI. The reaction medium may be a biphasic (aqueous/organic) solution, especially when the alkali metal salt used in step c) is an aqueous solution. In this case, the method may comprise a phase separation step, during which the aqueous phase is removed and the alkali metal salt of FSI is recovered in the organic phase. Additional steps may comprise filtration, concentration, extraction, recrystallization, purification by chromatography, drying and/or formulation.

By carrying out step c) according to the process of the invention, an onium salt is formed as by-product. This by-product may be eliminated by conventional methods known by the skilled person. More advantageously, it may alternatively be recycled to prepare an onium halide other than an onium fluoride that may be used in step a) and/or an onium fluoride that may be used in step b). Any known method by the skilled person may be used in that respect. After isolation of the onium salt from the reaction medium, one or more drying operations, as well as purification operations of the onium salt, may be carried out. For instance, the method depicted in U.S. Pat. No. 4,075,306 may be used to dry the onium salt. Any conventional method may be used thereto. According to a particular embodiment of the process according to the invention wherein an alkali metal hydroxide (or hydrate thereof) is used as alkali metal salt to carry out step c), an onium hydroxide is formed as by-product. This by-product may be eliminated by conventional methods known by the skilled person. More advantageously, it may alternatively be recycled, especially to prepare an onium halide other than an onium fluoride that may be used in step a) and/or an onium fluoride that may be used in step b). More particularly, the onium hydroxide by-product formed in step c) may be reacted with the hydrogen halide by-product formed in step a) to prepare an onium halide that may be used to carry out step a). The skilled person knows the conditions in which such a reaction can be carried out. Such recycling loops are very suitable to improve the cost-efficiency and environmental impact of the process.

Generally speaking, all raw materials used in the method according to the invention, including solvents, reagents, etc., may preferably show very high purity criteria. Preferably, their content of metal components such as Na, K, Ca, Mg, Fe, Cu, Cr, Ni, Zn, is below 10 ppm, more preferably below 2 ppm.

In addition, some of the steps or all steps of the method according to the invention are advantageously carried out in equipment capable of withstanding the corrosion of the reaction medium. For this purpose, materials are selected for the part in contact with the reaction medium that are corrosion-resistant, such as the alloys based on molybdenum, chromium, cobalt, iron, copper, manganese, titanium, zirconium, aluminum, carbon and tungsten, sold under the Hastelloy® brands or the alloys of nickel, chromium, iron and manganese to which copper and/or molybdenum are added, sold under the name Inconel® or Monel™, and more particularly the Hastelloy C276 or Inconel 600, 625 or 718 alloys. Stainless steels may also be selected, such as austenitic steels and more particularly the 304, 304L, 316 or 316L stainless steels. A steel having a nickel content of at most 22% by weight, preferably of between 6% and 20% and more preferentially of between 8% and 14%, is used. The 304 and 304L steels have a nickel content that varies between 8% and 12%, and the 316 and 316L steels have a nickel content that varies between 10% and 14%. More particularly, 316L steels are chosen. Use may also be made of equipment consisting of or coated with a polymeric compound resistant to the corrosion of the reaction medium. Mention may in particular be made of materials such as PTFE (polytetrafluoroethylene or Teflon) or PFA (perfluoroalkyl resins). Glass equipment may also be used. It will not be outside the scope of the invention to use an equivalent material. As other materials capable of being suitable for being in contact with the reaction medium, mention may also be made of graphite derivatives. Materials for filtration have to be compatible with the medium used. Fluorinated polymers (PTFE, PFA), loaded fluorinated polymers (Viton™), as well as polyesters (PET), polyurethanes, polypropylene, polyethylene, cotton, and other compatible materials can be used.

Advantageously, the alkali metal salt of FSI obtained by the method according to the invention has a very high purity. It may show a purity of salts above 90%, preferably above 95%, more preferably between 99% and 100%.

Preferably, it may show the following contents of anions (which are compounds different from the alkali metal salt of FSI itself):
a chloride (Cl⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or
a fluoride (F⁻) content of below 10,000 ppm, preferably below 5,000 ppm, more preferably below 1,000 ppm, more preferably below 500 ppm, more preferably below 100 ppm, more preferably below 50 ppm, more preferably below 20 ppm; and/or
a sulfate (SO₄²⁻) content of below 30,000 ppm, preferably below 10,000 ppm, more preferably below 5,000 ppm.

Preferably, it may show the following contents of metal elements:
an iron (Fe) content of below 1,000 ppm, preferably below 800 ppm, more preferably below 500 ppm; and/or
a chromium (Cr) content of below 1,000 ppm, preferably below 800 ppm, more preferably below 500 ppm; and/or
a nickel (Ni) content of below 1,000 ppm, preferably below 800 ppm, more preferably below 500 ppm; and/or
a zinc (Zn) content of below 1,000 ppm, preferably below 100 ppm, more preferably below 10 ppm, and/or
a copper (Cu) content of below 1,000 ppm, preferably below 100 ppm, more preferably below 10 ppm; and/or
a bismuth (Bi) content of below 1,000 ppm, preferably below 100 ppm, more preferably below 10 ppm.

Additionally, when the alkali salt of FSI is not NaFSI, it may show:
a sodium (Na) content of below 10 000 ppm, preferably below 5 000 ppm, more preferably below 500 ppm.

Additionally, when the alkali metal salt of FSI is not KFSI, it may show:
a potassium (K) content of below 10 000 ppm, preferably below 5 000 ppm, more preferably below 500 ppm.

Thanks to its very high purity, the alkali metal salt of FSI, and preferably LiFSI, obtainable by the method according to the invention, may be advantageously used in electrolyte compositions for batteries.

Should the disclosure of any patents, patent applications, and publications which are incorporated herein by reference conflict with the description of the present application to the extent that it may render a term unclear, the present description shall take precedence.

The invention will now be further described in examples, which are given by way of illustration and which are no intended to limit the specification or the claims in any manner.

### EXAMPLES

### Example 1 Bis(Chlorosulfonyl)Imide Ammonium Salt Formation

A tri-necked 250 mL glass flask was equipped with a thermometer, a mechanically-stirred 4-blades shaft and a screw-type solid-addition head, and was connected to a KOH-scrubber via PTFE tubing. The system was flushed with Argon over 30 min before use. Bis(chlorosulfonyl)imide (52.6 g, 244 mmol) was melted in a glovebox and cannulated under Argon into the flask, then was pre-heated at about 50° C. Anhydrous ammonium chloride (12.8 g, 239 mmol) was loaded into the solid dosing screw-type glass apparatus, and was gradually added over 0.5 h under Argon flow. The mixture was heated at 60° C. during 1 h then at 75-80° C. over 2 h until the mixture reached 58.2° C. and gas evolution stopped. HCl was neutralized in the KOH-scrubber and chlorine content was recovered by ionic chromatography. NH₄CSI was isolated as a colourless very thick oil (51.4 g).

### Example 2 Bis(Fluorosulfonyl)Imide Ammonium Salt Formation

The product obtained in example 1 was dissolved in ethyl methyl carbonate (50 g) under magnetic stirring over 15 min at 45° C. This solution was cooled to room temperature and cannulated under Argon into a suspension of anhydrous NH₄F (18.3 g, 493 mmol) in ethyl methyl carbonate (100 g) pre-heated at 40° C. over 15 min. A white suspension was rapidly observed, the mixture was stirred at 73° C. during 3 h. After cooling, the suspension was filtered under suction in the air. The resulting filtrate contained 45.7 g of NH₄FSI (representing a yield of 94.5% based on the CSIH initially introduced in example 1) and traces of impurities, as measured by 19F-NMR analysis. The solid cake was formed of NH₄Cl (24.5 g), ammonium fluoride (1.3 g), traces of ammonium bifluoride and residual ethyl methyl carbonate according to 1H/19F-NMR analysis.

### Example 3 Bis(Fluorosulfonyl)Imide Lithium Salt Formation

NH₄FSI (29.7 g, 0.15 mol) obtained in example 2 was solubilized in ethyl methyl carbonate (300 g) and cooled to 0° C. A 25 wt. % aqueous solution of LiOH·H₂O (6.9 g) was added. The obtained biphasic mixture was stirred during 21 hours at room temperature, and then decanted. The organic phase was recovered and put into a thin film evaporator at 60° C. under reduced pressure (10⁻¹ bar). The purity of the obtained LiFSI (25.3 g) was above 99.9%, and chlorine and fluorine contents were below 20 ppm. LiFSI total yield was 90% (based on the NH₄FSI initially introduced in example 3).

### Comparative Example 4: Bis(Fluorosulfonyl)Imide Ammonium Salt Formation

A suspension of NH₄F (157.4 g, 4.24 mol) in ethyl methyl carbonate (620 g) was prepared into a vessel equipped with mechanical stirring and pre-heated at 60° C. Melted bis(chlorosulfonyl)imide (192.3 g, 0.89 mol) was introduced over 4 h. After complete addition, the mixture was heated at 73° C. for 26 h. The vessel was emptied and the mixture was filtered, providing a filtrate and a solid cake (246.4 g). The filtrate contained NH₄FSI (155.9 g, yield 88%) according to 19F-NMR analysis. The solid wet cake was composed of ammonium chloride (84.1 g), ammonium fluoride (54.9 g) and ammonium bifluoride (51 g) plus residual ethyl methyl carbonate according to 1H/¹⁹F-NMR analysis.

1. A method for producing an onium salt of bis(fluorosulfonyl)imide, comprising the steps of:
a) reacting a bis(chlorosulfonyl)imide (or salt thereof) with an onium halide other than an onium fluoride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a),
b) reacting the onium salt of CSI with an onium fluoride to produce an onium salt of bis(fluorosulfonyl)imide (onium salt of FSI).

2. The method according to claim 1, wherein the onium halide used in step a) is an onium chloride.

3. The method according to claim 1, wherein the onium cation of the onium halide used in step a) is selected from the group consisting of an imidazolium cation, pyridinium cation, quaternary ammonium cation, tertiary ammonium cation, secondary ammonium cation, primary ammonium cation, ammonium cation, piperidinium cation, pyrrolidinium cation, morpholinium cation, pyrazolium cation, guanidinium cation and isouronium cation.

4. The method according to claim 1, wherein the molar ratio of the onium halide to the bis(chlorosulfonyl)imide (or salt thereof) ranges from 0.001:1 to 20:1.

5. The method according to claim 1, wherein a hydrogen halide other than hydrogen fluoride is formed as by-product in step a) and recycled to produce an onium halide other than an onium fluoride usable in step a).

6. The method according to claim 1, wherein the onium cation of the onium fluoride used in step b) is the same as the onium cation of the onium halide used in step a).

7. The method according to claim 1, wherein the molar ratio of the onium fluoride to the onium salt of bis(chlorosulfonyl)imide ranges from 2:1 to 20:1.

8. The method according to claim 1, wherein an onium chloride is formed as by-product in step b) and recycled by use thereof as onium halide to carry out step a).

9. The method according to claim 1, wherein the onium fluoride used in step b) is according to formula:
NH₄F(HF)ₚ
in which p varies between 0 and 10.

10. The method for producing an alkali salt of bis(fluorosulfonyl)imide, comprising the steps of:
a) reacting a bis(chlorosulfonyl)imide or a salt thereof with an onium halide other than an onium fluoride to produce an onium salt of bis(chlorosulfonyl)imide (onium salt of CSI), wherein the step is carried out in molten bis(chlorosulfonyl)imide (or salt thereof), in the absence of solvent or in the presence of a solvent less than 5 wt. % based on the total weight of the reaction mixture involved in step a),
b) reacting the onium salt of CSI with an onium fluoride to produce an onium salt of bis(fluorosulfonyl)imide (onium salt of FSI),
c) reacting the onium salt of FSI with an alkali metal salt to obtain an alkali metal salt of bis(fluorosulfonyl)imide (alkali metal salt of FSI).

11. The method according to claim 4, wherein the alkali metal salt in step c) is selected from alkali metal hydroxides, alkali metal hydroxide hydrates, alkali metal carbonates, alkali metal hydrogen carbonates, alkali metal chlorides, alkali metal fluorides, alkali metal alkoxide compounds, alkyl alkali metal compounds, alkali metal acetates, and alkali metal oxalates.

12. The method according to claim 10 wherein the alkali metal salt used in step c) is an alkali metal hydroxide or an alkali metal hydroxide hydrate so that an onium hydroxide is formed as by-product in step c) and wherein said onium hydroxide is recycled to produce an onium halide other than an onium fluoride that may be used in step a) and/or an onium fluoride that may be used in step b).

13. The method according to claim 12, wherein said onium hydroxide is recycled by reaction thereof with a hydrogen halide by-product formed in step a) to produce an onium halide usable to carry out step a).

14. The method according to claim 3, wherein the onium cation of the onium halide used in step a) is an ammonium cation.

15. The method according to claim 4, wherein the molar ratio of the onium halide to the bis(chlorosulfonyl)imide (or salt thereof) ranges from 0.1:1 to 10:1.

16. The method according to claim 4, wherein the molar ratio of the onium halide to the bis(chlorosulfonyl)imide (or salt thereof) ranges from 0.5:1 to 5:1.

17. The method according to claim 7, wherein the molar ratio of the onium fluoride to the onium salt of bis(chlorosulfonyl)imide ranges from 2:1 to 5:1.

18. The method according to claim 7, wherein the molar ratio of the onium fluoride to the onium salt of bis(chlorosulfonyl)imide ranges from 2:1 to 3:1.

19. The method according to claim 7, wherein the molar ratio of the onium fluoride to the onium salt of bis(chlorosulfonyl)imide ranges from 2:1 to 2.5:1.

20. The method according to claim 5, wherein the alkali metal salt in step c) is an alkali metal hydroxide or an alkali metal hydroxide hydrate.
